(19) United States
(12) Patent Application Publication
(10) Pub. No.: US 2011/0298464 A1
(43) Pub. Date: Dec. 8, 2011

(54) DUAL VOLTAGE BATTERY TESTER

(76) Inventors: Robert Parker, Bend, OR (US); Charles J. Sapienza, Libertyville, IL (US)

(21) Appl. No.: 13/152,444

(22) Filed: Jun. 3, 2011

Related U.S. Application Data
(60) Provisional application No. 61/351,493, filed on Jun. 4, 2010.

(51) Int. Cl. G01N 27/416

(52) U.S. Cl. 324/435

(57) ABSTRACT

A dual voltage battery tester for testing both 1.5 volt and 9 volt batteries is printed on a thin substrate with a reversible thermo-chromatic material in thermal contact with carbon heating elements. The heating elements use the same carbon resistive ink for bolt voltage ranges and is printed as a single pass.

### FIELD OF THE INVENTION

The present invention relates to a thick film printed, dual voltage battery tester suitable for use with both 1.5 volt and 9 volt batteries that allows efficiencies of manufacture and greater user friendliness than the prior art.

### BACKGROUND OF THE INVENTION

U.S. Pat. Nos. 4,702,563; 4,702,564; 4,726,661; 4,737,020 issued to Robert Parker disclose printed thin film battery testers that use a silver-carbon conductive ink mixture to produce a tapered, resistive heating element on a thin 0.005 inch plastic substrate. When a voltage or current was applied to this resistive heating element a temperature gradient heated a reversible thermochromic material that was in thermal contact with the resistive tapered heating element. A thermochromic color change would be triggered and a resulting moving color band would indicate the applied voltage that could be related to the percent energy left in the battery. The length of the color change along the axis of the taper showed the applied voltage, a longer color band indicating higher voltages. A printed reticule or scale adjoining the taper indicated the percent energy remaining in the battery.

U.S. Pat. No. 5,128,616 issued to Allan Palmer discloses a similar concept using carbon ink based heating elements printed between two printed silver conductive bus bars on a polyester substrate. Palmer's device used three or four carbon resistive heating elements with the stepped configuration of the conductive bus bars determining the effective electrical path lengths of the elements as shown in FIG. 1 and FIG. 1A. As in the Parker design a reversible thermo chromatic material (ink) is printed over a colored background, both in thermal contact with the carbon heating elements as shown in FIG. 1 and FIG. 1a. An additional, non-visual heating element could be parallel inserted between the buss bars to adjust the tester's input impedance to match the tester's input impedance to the proper battery loading resistance.

Attempts in the prior art to design an effective, easy to use, and efficiently silk screen printable battery tester suitable for use across two or more standard battery ranges e.g. 1.5v, 9v have not been successful.

The governing set of design equations coupling the tester geometries, and the electrical and thermal heat balances for both historic battery tester designs and the present invention is shown below:

E=V²/R 1)

Where V=applied voltage (volts) across the heating element
R=electrical resistance across the carbon heating element
L=spacing between silver buss bars (in), electrical path length
W=width of the carbon heating element (in)

R=rₛₕₜ×L/W 2)

rₛₕₜ=Printed sheet resistivity of carbon heating element (ohms/SQ)
=rₒ/t where t is the cured thickness of the resistive ink. and rₒ is a property of the resistive ink used in the printing.

E=V²×W/(L×rₛₕₜ) 3)

Q=h×A×DT 4)

Q=convective heat transfer from the carbon heating element
h=coefficient of convective heat transfer for the heating element
A=area of the carbon heating element=L×W
DT=the temperature difference between the heating element and ambient conditions.
   At equilibrium the electrical energy into each heating element will just balance the thermal energy most through free convection from the heating elements:

E=Q V²×W/(L×rₛₕₜ)=h×A×DT 5)

E=h×DT=(V²/L²)/(h×rₛₕₜ) 6)

E=energy density (watt/in²)

DT=(V²/L²)/(h×rₛₕₜ) (7)

L=V/SQRT(DT×h×rₛₕₜ) 8)

spacing between silver buss bars required to heat the carbon element by a required DT for a fixed geometry and given rₛₕₜ.
Equations 7) and 8) require a given watt density to heat the thermo chromatic material above its color change threshold temperature for a given ambient temperature such as 20-21° C.

Typical cured sheet resistance, r, for available silk screen carbon inks are 30-400 ohms/SQ @1 mil. With the cured thickness of the inks typically at 0.5 mil, the resulting sheet resistivity, rₛₕₜ will be 60-800 ohms/SQ. The sheet resistance of the conductive silver inks used to print the bus bars is typically 0.015 ohms/SQ @1 mil. These carbon resistive and silver conductive inks can be purchased from ECM, DuPont, Acheson Colloids, and other suppliers. The reversible thermo-chromatic materials can be purchased from LCR Hallcrest in Chicago, Ill., USA, or Matsui in Japan.

Nine volt batteries operate nominally at 6 times the voltage and 36 times the energy levels as 1.5 volt batteries. Testers must additionally indicate voltages bracketing the lower and higher limits for the intended batteries thus spanning energy ranges of 50× or more.

For a fixed rₛₕₜ, and applying the Parker design per equation 8 to a 1.5 volt/9 volt combination tester would require the tapered resistor for the nine volt battery to be 7× or more longer than the 1½ in. to 2 in. length of the 1.5 volt tapered resistor used in the Parker tester. The Palmer design results in similar ratios. This leads to impractical dimensions for a single tester to accommodate both voltage ranges while attempting to use only a single resistive material applied in a single resistive printing.

### SUMMARY OF THE INVENTION

The present invention is intended for thick film printing using any of the different varieties of silk screen printing equipments: flat bed, cylinder, or rotary press.

The invention enables a dual voltage battery tester to be manufactured without requiring either separate resistive inks or separate resistive ink printing passes of the same ink at different thicknesses that would normally be required to handle the large spread of power densities associated with the dual battery voltage ranges. The invention introduces designs and techniques that efficiently and effectively solve issues arising from the inherent variability in the thickness of the silk screen printed resistive inks. The present design and printing techniques therefore allow the production of dual range battery testers utilizing simple screen printing processes.

By decreasing the sheet resistivity of the carbon heating elements, the electrical path length (spacing) between the 1.5 volt silver bus bars can be increased to 0.010 inches to 0.04 inches which approaches the lower limit of registration for resistive ink silk screen printing. It was found that a carbon sheet resistivity, rₛₕₜ, of 80-100 ohms/SQ was a practical value range. The resulting maximum dimension electrical path lengths for the 1½ and 9 volt heat elements would be about 0.20 and 0.90 inches respectively. While the present invention introduces concepts that reduce the physical length footprints for the 9v testing circuits, the concepts can be extended to other applications where wide voltage ranges must be accommodated. The advantage of this design using the silver buss bars and carbon heating elements over the prior art Parker design using the carbon/silver amalgam is that only the resistivity of the carbon ink printing is critical, thus eliminating the other printing resistive variables. The silver buss bars need only be printed to be as conductive as practical with no tight conductance specifications.

To reduce the overall footprint and costs, the testers were designed to share a common silver buss bar between the 1½ and 9 volt tester circuits. In addition various methods were designed to reduce the size of the tester's footprint. The testers are desirably printed in batch processes so the larger the number of testers printed per sheet the lower the process and materials costs. Another desirable design feature incorporated into the present invention was to make the thermo chromatic indicators change in the same way for both the 1½ and 9 volt scales so that the battery indications would be easier to read.

### BRIEF DESCRIPTION OF THE DRAWINGS

FIGS. 1 and 1a are schematics showing the prior art Palmer design. FIG. 1 shows the underside 1 of the printed substrate 00 with its silver conductive bus bars 2, 3 and carbon printed heating elements 4, 5, 6. 7 and 8 are printed silver conductive pads used to make contact with the respective + and − terminals of the battery being tested.

FIG. 1a shows the topside 10 of the printed substrate 00 with the thermochromic material segments 11, 13, 15 printed over their associated and noticeably different colored indicator segments 12, 14, 16, and printed in thermal contact through the thin substrate 00 with the underside heating elements 4,5,6. 19 shows the printed scale aligned with the thermochromic segments.

FIGS. 2 and 2a are schematics showing one embodiment of the present invention based upon use of a grid patterned carbon printing of selective heating elements.

FIGS. 3 and 3a are schematics showing another embodiment of the present invention based upon a folded carbon heating element design.

FIGS. 4 and 4a are schematics showing still another embodiment of the present invention enabling a dual voltage battery tester with analog, percent indication of battery charge status.

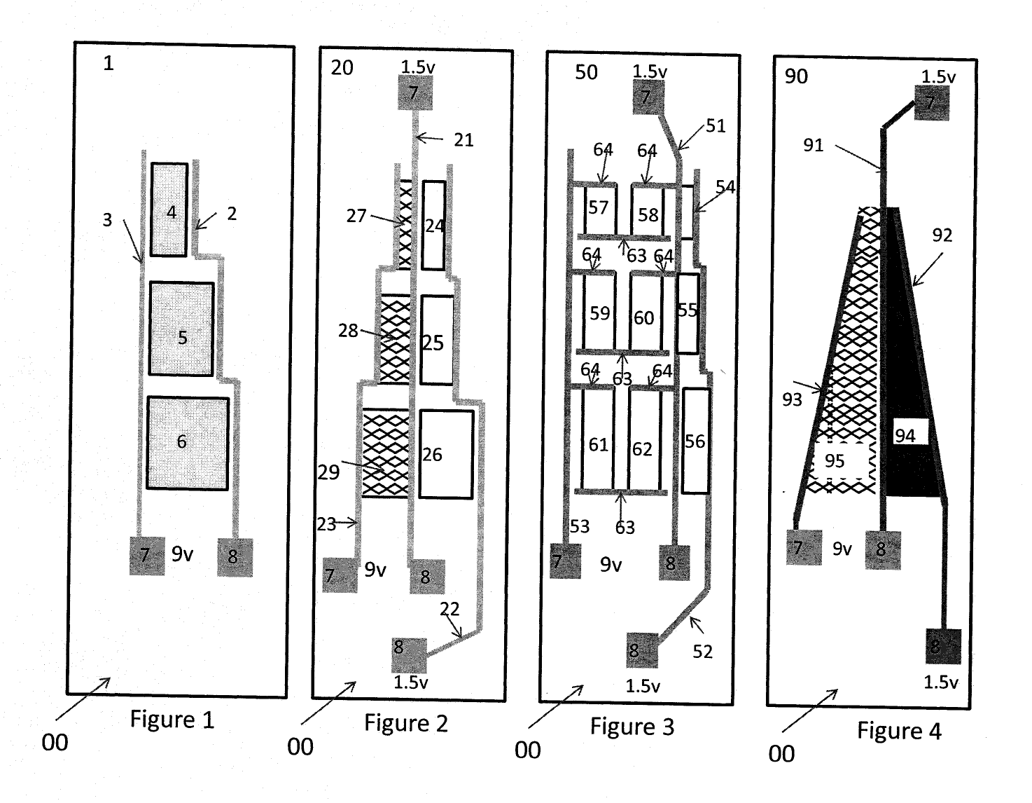

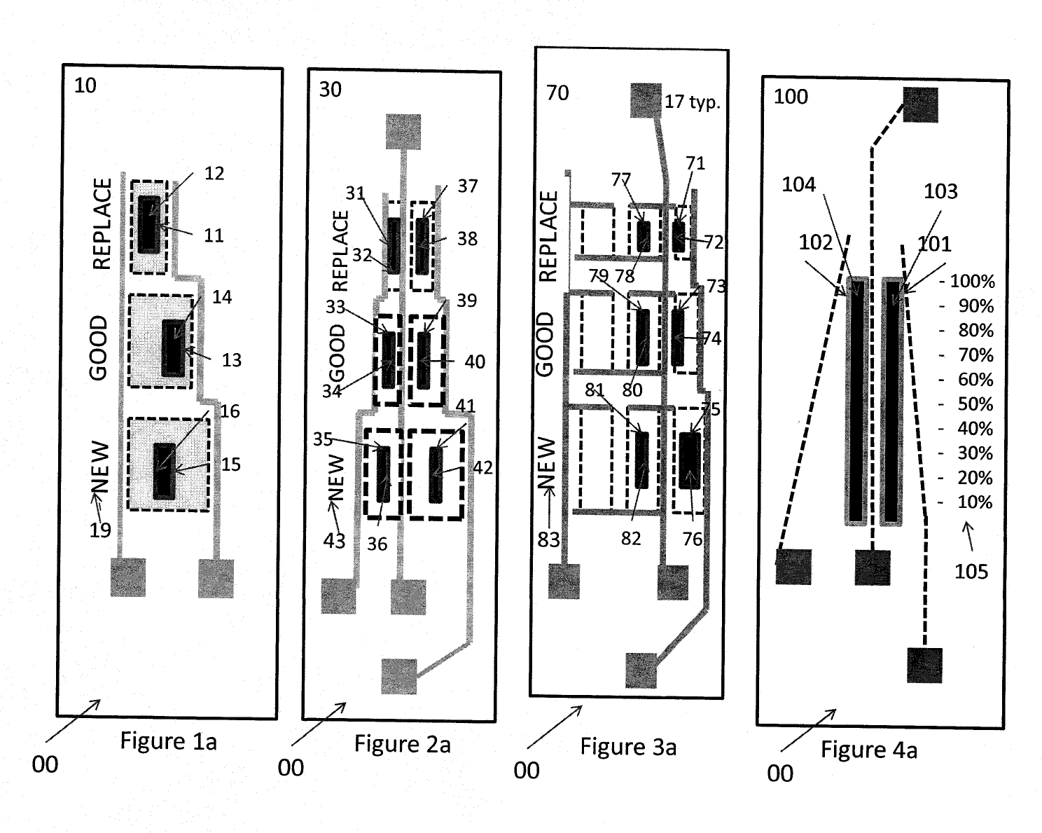

### DETAILED DESCRIPTION OF THE INVENTION

The devices embodying the present invention as shown in FIGS. 2, 2a and FIGS. 3, 3a use two different design concepts. FIGS. 4, 4a incorporate present invention concepts to provide an analog percent indication of battery charge status for a dual voltage battery tester.

The embodiment shown in FIGS. 2, 2a use a printed carbon grid pattern to selectively alter the sheet resistivity, rₛₕₜ of the different heating elements while using s a single resistive ink, and a single printing thickness.

FIG. 2 shows the underside 20 of the printed substrate 00 with its silver conductive buss bars 21, 22, 23 with 21 being a shared silver conductive buss bar, 1.5v carbon printed heating elements 24, 25, 26, and 9v carbon grid patterned printed heating elements 27, 28, 29.

FIG. 2a shows the topside 30 of the printed substrate of FIG. 2 with the 1.5v thermochromic material segments 31, 33, 35 printed over their associated and noticeably different colored indicator segments 32, 34, 36, and 9v thermochromic material segments 37, 39, 41 printed over their associated and noticeably different colored indicator segments 38, 40, 42. Both are printed in thermal contact through the thin substrate 00 with the underside heating elements 24 through 29. 43 shows the printed scale common to both the 1.5v and 9v tester circuits aligned with the thermochromic segments.

This embodiment which uses a grid pattern exhibiting higher values of rₛₕₜ in the 9v circuit heating elements 27, 28, 29 and a solid pattern exhibiting lower values of rₛₕₜ in the 1.5v circuit heating elements 24, 25, 26, allows reduction in the dimension ratios that would normally be required to handle and indicate the voltage ranges of the dual battery tester, resulting in compact, practical, economical testers. This also allows the 1.5 volt and 9 volt indications to share a common user friendly scale 43.

The embodiment shown in FIGS. 3, 3a uses a somewhat different approach to solve the dimension ratio problems associated with a practical dual-range voltage tester. This approach prints each of the longer carbon heating elements as a set of shorter carbon segment pairs 57-58, 59-60, 61-62. The segments are aligned in a folded array utilizing silver connections 63, 64 normal to the main parallel buss bars 21, 22, 23.

FIG. 3 shows the underside 50 of the printed substrate 00 with its silver conductive buss bars 51, 52, 53 with 51 being the shared buss bar, 1.5v carbon printed heating elements 54, 55, 56, and 9v carbon printed folded heating elements 57-58, 59-60, 61-62 where 57-58, 59-60, 61-62 designate the half segments of the folded heating elements design. Silver conductive printed tie bars 63 provide electrical continuity between the two half segments of each of the heating elements. Silver conductive printed bars 64 provide a means of connecting each of the 9v folded heating elements to the buss bars 51 and 53 while providing a thermal standoff space to prevent thermal crosstalk between the 9v and 1.5v circuits.

FIG. 3a shows the topside 70 of the printed substrate of FIG. 3 with the 1.5v thermochromic material segments 71, 73, 75, printed over their associated and noticeably different colored indicator segments 72, 74, 76, and 9v thermochromic material segments 77, 79, 81 printed over their associated and noticeably different colored indicator segments 78, 80, 82. These are printed in thermal contact through the thin substrate 00 with its associated 1.5v heating elements 54, 55, and 56 or its associated 9v half-segment heating elements 57-58, 59-60 and 61-62. 83 shows the printed scale common to both the 1.5 and 9v tester circuits aligned with the thermochromic segments.

This normal orientation of the silver connectors together with the folded design effectively allows lengthening of the electrical path length of the 9 volt heating elements while reducing the physical footprint lengths of the tester. This normal orientation and folded design also allows the thermochromic material in contact with the resistive carbon heating elements for both the 1.5 volt and 9 volt tester circuits to be printed next to each other using the same scale or reticule 83 to indicate LOW, MED, and HIGH or REPLACE, GOOD, NEW battery charge status. This is in contrast with the tester design discussed in Palmer's U.S. Pat. No. 5,128,616. It should further be noted that the normal silver connectors 64 provide standoff spacing between the visual 9 volt heater elements 58, 60, 62 and each of their adjacent 1.5 volt heating elements 54, 55, 56, reducing the heat transfer from the 9 volt tester during its use from heating the 1.5 volt elements and preventing miss-indication through thermal crosstalk that may cause indicating confusion for the user.

FIG. 2 shows the printed carbon resistors and the silver buss bars and normal connecting elements as well as the contact pad sets 7, 8 for the 1.5 volt and 9 volt battery. FIG. 2a shows the reticule 43 and the relative position of the thermochromic indicators. This is also true for FIG. 3. However FIG. 2 is the preferred configuration because one may more readily adjust the test load resistance for the battery.

The embodiment shown in FIGS. 4, 4a enables a dual voltage battery tester with analog, percent indication of battery charge status. FIG. 4 shows the underside 90 of the printed substrate 00 with its silver conductive buss bars 91, 92, 93 and tapered carbon printed heating elements 94, 95. The 9v heating element 95 uses the present invention concept of the printed grid pattern to reduce the dimensional ratio between the 1.5v and 9v batteries.

FIG. 4a shows the topside 100 of the printed substrate of FIG. 4 with the thermochromic material 101, 102 printed over their associated and noticeably different colored indicator segments 103, 104. These are printed in thermal contact through the thin substrate 00 with their associated 1.5v heating element 94, and associated 9v heating elements 95. 105 shows the percent indicator graphics common to both the 1.5v and 9v testers.

For all embodiments of the present invention the heating elements are aligned so that the 1½ and 9 volt share a common reticule or scale avoiding confusion.

For all embodiments of the present invention the temperature change point for the thermochromic material is chosen to be between 45° C. and 48° C.

### Advantages of These Concepts

1. Both the 9 volt and 1½ volt circuits can use the same stable printable carbon resistive ink. This also means that only a single printing of the resistive ink is required to provide a range of sheet resistivities reducing the number and cost of the printings. The use of a single printing and single carbon resistive ink reduces the error stack-ups resulting from the inherent thickness variability in silk screen printing.
2. A shared silver conductive Buss Bar is used for both the 1½ volt and 9 volt circuits, reducing the quantity of the costly silver conductive ink.
3. The use of a folded heating element constructed of 2 or more half-segments and designed with silver traces printed normal to the buss bars for the higher voltage testing circuits enables the electrical path length of the heating elements to be effectively lengthened while actually reducing the length footprint of the overall tester.
4. The use of a printed grid carbon pattern provides a method to change the resistivity of the carbon ink across different areas on the tester as an alternative or supplement to a purely dimensional solution. This can be used to reduce the length ratios of the heating elements and hence the size of the testing unit footprint.
5. A design of narrow varying lengths of the 9 volt heaters arranged side by side to reduce the width of the tester and hence the cost.
6. The arrangement of the heating elements and thermo-chromatic materials such that the visual change is the same for both the 9 volt and 1½ volt indications providing greater readability for the user.

7. A standoff space between the 1.5 volt and 9 volt heating elements provide a thermal isolation to prevent miss indication through thermal crosstalk.
8. A preferred and novel screen printing technique whereby the carbon resistive heating elements are printed before the silver conductive bus bars allowing an exact electrical path length can be established and the silver conductive buss bars printed over the carbon based upon the exact “as printed-as cured” resistivity of the carbon heating elements. This allows any run-to-run or screen area-to-screen area thickness variability to be compensated for thus increasing tester consistency and yields.

What is claimed:

1. A 1½ volt and 9 volt battery tester printed on a thin substrate with a reversible thermo-chromatic material in thermal contact with carbon heating elements where s the heating elements use the same carbon resistive ink, and where the carbon resistive ink for both voltage ranges is printed as a single pass.

2. A battery tester as in 1) where the 1½ and 9 volt printed circuits share a common silver buss bar.

3. A battery tester as in 1) where the heating elements and thermo-chromatic indications change in the same visual manner to indicate status of battery charge.

4. A battery tester as in 3) where a reticule or scale is the same for the 1½ volt and 9 volt indications

5. A battery tester as in 1) where a grid pattern carbon resistor is printed to increase the resistance or sheet resistivity to reduce the dimensional ratios required to handle the 1½ volt and 9 volt distances between the printed silver buss bars.

6. A battery tester as in 1) using a folded series of shorter carbon segments with silver connections printed normal to the main buss bars to construct the longer electrical path length carbon heating elements in a shorter tester footprint.

7. A standoff space between the 9 volt and 1.5 volt heating elements to provide thermal isolation between the two circuits and prevent thermal crosstalk from causing miss-indications.

8. A dual voltage battery tester as in 5) with continuous taper heating elements with silver conductive buss bars running along both sides of the tapered heating elements, and a shared silver conductive buss bar between the heating elements, providing a percent analog indication of battery charge status.
